(19) United States
(12) Patent Application Publication
(10) Pub. No.: US 2006/0253241 A1
(43) Pub. Date: Nov. 9, 2006

(54) Device for adjusting at least one vehicle seat

(76) Inventors: Hans-Dieter Bothe, Seelze (DE); Hoang Trinh, Ditzingen (DE); Heiko Freienstein, Weil Der Stadt (DE); Thomas Engelberg, Hildesheim (DE)

Correspondence Address: KENYON & KENYON LLP, ONE BROADWAY, NEW YORK, NY, 10004, US

(21) Appl. No.: 10/543,645

(22) PCT Filed: Oct. 17, 2003
(86) PCT No.: PCT/DE03/03448

§ 371 Date: Feb. 21, 2006

(30) Foreign Application Priority Data
Feb. 7, 2003 (DE) 103 05 013.2

(51) Int. Cl. E05F 15/00

(52) U.S. Cl. 701/49

(57) ABSTRACT

A device for adjusting at least one vehicle seat is provided, the device being configured to automatically adjust the at least one vehicle seat. Furthermore, the device is configured in such a way that the device adjusts a contour of the at least one vehicle seat as a function of a signal from an image-generating sensory system, which detects a vehicle occupant on the vehicle seat.

### FIELD OF THE INVENTION

The present invention is directed to a device for adjusting at least one vehicle seat.

### BACKGROUND INFORMATION

Published German patent document DE 196 51 670 discloses a device for adjusting seat components of a vehicle seat, which adjustment is based on the correct seating position. In the process, to better protect the vehicle occupant in a rear collision, a head rest is automatically adapted to the vehicle occupant especially as a function of a sensor signal.

### SUMMARY

The device according to the present invention for adjusting at least one vehicle seat has the advantage over the known art that, due to the use of a sensory system that measures in a contactless manner, the device is able to monitor the posture of the person in an optimal manner during driving, thereby better supporting and securing that person in his or her movements via a modification of the seat contour. The sensory system may have an image-generating or distance-generating design. This may be particularly useful especially for vehicle seats that provide good lateral support, for instance when the upper torso is rotating backward while the vehicle is driven in reverse. This results in better overall seating comfort in the vehicle.

It is particularly advantageous that the image-generating sensory system includes video sensors, which are designed to perform monocular, stereoscopic or distance measurements, thereby allowing better detection of the vehicle occupant or his/her posture. Apart from the posture, the image-generating sensor system may also detect the view direction, or the orientation, as well as the head position, thereby allowing appropriate support of the movements of the vehicle occupant.

Furthermore, signals from sensors for detecting kinematic variables in the vehicle may likewise be utilized for adjustment of the seat contour. Such sensors, in particular, are speed sensors, acceleration and roll-over sensors, or also sensors which sense that a reverse gear is engaged, in order to support the special seating position while the driver is backing up.

In addition, sensors that directly record the instantaneous adjustment of the seat contour may be used as well. For example, these are sensors which are directly assigned to the actuators in order to detect the movement of moveable seat elements, such as strain-gauges or also magnetic concepts using Hall elements, for instance. Sensors of this type then allow feedback as to whether the change in the seat contour is optimal for the instantaneous driver pose.

### BRIEF DESCRIPTION OF THE DRAWINGS

FIG. 1 shows a first exemplary embodiment of the device according to the present invention.

FIG. 2 shows a second exemplary embodiment of the device according to the present invention.

### DETAILED DESCRIPTION

According to the present invention, a device for adjusting at least one vehicle seat is provided, which allows the seat contour to be modified as a function of a signal from a sensory system that detects and measures in a contactless manner poses of the vehicle occupant in a reliable manner. The sensory system may have an image-generating or distance-measuring design. This enhances driving comfort and facilitates steering of the vehicle. In addition, the safety may be increased in this manner in that the vehicle occupant is optimally prepared for a crash by an adjustment of the seat.

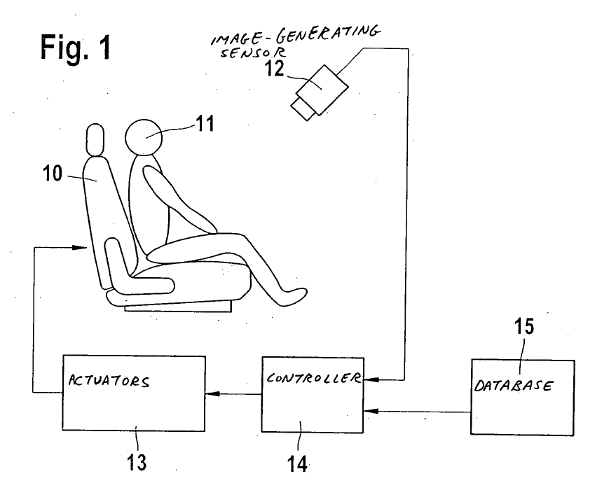

FIG. 1 shows a first exemplary embodiment of the device for adjusting at least one vehicle seat according to the present invention. That is to say, the device may also be used to adjust several vehicle seats, in particular to adjust all vehicle seats in a vehicle. However, it is possible that each vehicle seat is provided with its individual device.

A seat 10 is occupied by a person 11. This person's pose is recorded by an image-generating sensor system 12. The head position and the orientation of the person are also ascertained by image-generating sensory system 12. To this end, image-generating sensory system 12 includes corresponding evaluation means, which then transmit a signal to a controller 14 as a function of the detected pose of the head position and the person's orientation. Image-generating sensory system 12 may be configured as video sensor, for example. This video sensor can be designed as monocular, stereoscopic or directly depth-gauging video sensor (time-of-flight measuring principle, for instance), or a whole array of video sensors may be provided as well. Instead of a video sensor, the image-generating sensory system may also utilize other forms of transmitted sensing signals, such as ultrasound or microwave signals as well and also infrared signals, all of which are suitable for detecting and monitoring a person's pose. As an alternative, sensory system 12 may have a distance-measuring design.

The evaluation means such as a processor having a corresponding memory, for instance, may be directly assigned to the image-generating sensory system 12, or they may be at a remote location in a control unit. Image-generating sensory system 12 may be connected to a bus, which is connected to controller 14. In that case, the image-generating sensory system has a bus controller, which allows communication via the bus. As an alternative, a two-wire connection may be provided between image-generating sensory system 12 and controller 14, for which, above all, a unidirectional data transmission from image-generating sensory system 12 to controller 14 is provided. This follows from the fact that only the signals that reproduce the pose of person 11 must be transmitted to controller 14, so that controller 14 is able to make the necessary adjustments to seat 10. If test modes or control signals are also possible for image-generating sensory system 12, the communication between controller 14 and image-generating sensory system 12 may have a bi-directional design.

Controller 14 also is a processor unit, which evaluates the signals from image-generating sensory system 12 reproducing the pose of person 11, and generates a control signal therefrom. Controller 14 generates this control signal with the aid of a characteristic curve for the seat-contour adjustment, which controller 14 obtains from a database 15. This database 15 may be a simple memory assigned to controller 14, which is able to permanently store the characteristic curves. However, it may also be a database which is connected to controller 14 via a bus. In that case, controller 14 will transmit the control signal to actuators 13 for adjustment of the seat contour. These actuators are characterized by corresponding electric motors, which are able to adjust the movable parts of seat 10. Counted among such movable parts are head rests, the various pads of the back rest and also side pads of seat 10. For instance, the backrest pad, which faces a rotating upper body, may then be moved back, whereas the pad of the back support facing away from the upper-body rotation may be extended further to lend support.

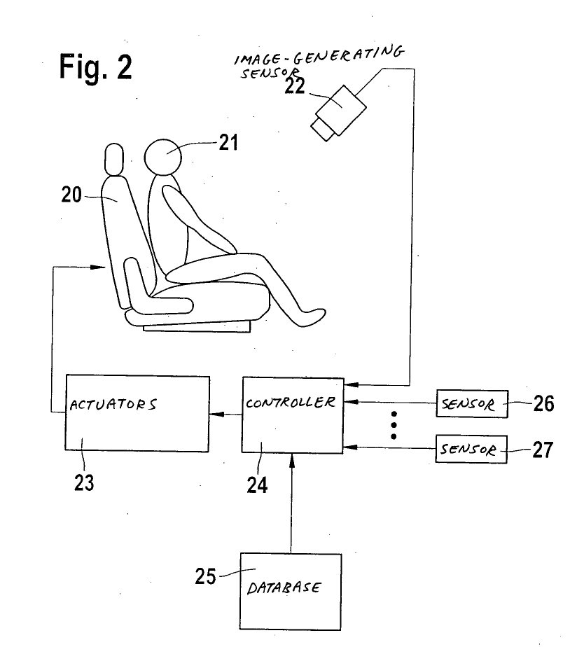

FIG. 2 shows a second exemplary embodiment of the device according to the present invention. A seat 20 once again holds a person 21. This person, who is seated in seat 20, is sensed by an image-generating sensory system 22. As already described earlier in connection with FIG. 1, image-generating sensory system 22 generates a signal for controller 24, the signal being generated as a function of the pose of person 21. In addition to the pose, the head position of person 21 or its orientation may also be reflected in the signal transmitted from image-generating sensory system 22 to controller 24. Controller 24 in turn utilizes a database 25 to load a characteristic curve for the seat-contour adjustment. In addition, sensors 26 and 27 are connected to controller 24, these sensors detecting kinematic variables of the vehicle, such as the velocity or occurring accelerations. These sensor signals may originate from an ESP control unit, for example, or from an airbag control unit or a kinematic sensor platform. Additional signals, for instance signals indicating which gear is engaged, e.g., the reverse gear, may be transmitted to controller 24 so as to allow an optimal adjustment of the seat contour. Furthermore, additional sensors, which directly record the currently adjusted seat contour, may be provided there in order to allow feedback for controller 24. Controller 24 in turn will transmit its actuating signal to actuators 23 for adjustment of the seat contour of seat 20.

The device according to the present invention may also be connected to a restraining system, thereby appropriately preparing a person for a crash as a function of the measured pose. Especially when a dangerous situation is detected by precrash sensors, for instance, or by signals from an ESP control unit which indicate skidding, for example, and if a crash is highly likely, a person may be prepared for such a crash by changing the seat contour. The device according to the present inventing may share an image-generating sensory system with an occupant detection mechanism for a restraining system, for instance.

1-7. (canceled)

8. A device for automatically adjusting at least one vehicle seat, comprising:
a sensory system for a contactless detection and measurement of an occupant of the at least one vehicle seat;
at least one actuator for changing a contour of the at least one vehicle seat as a function of a signal from the sensory system.

9. The device as recited in claim 8, wherein the sensory system is configured as one of a monocular video-sensor system, a stereoscopic video-sensor system, and a distance-measuring video-sensor system.

10. The device as recited in claim 8, wherein the sensory system is an image-generating sensory system that includes at least one of an ultrasound sensor and a microwave sensor.

11. The device as recited in claim 9, wherein the sensory system is configured to record at least one of a pose of the occupant of the at least one vehicle seat, an orientation of the occupant of the at least one vehicle seat, and a head position of the occupant of the at least one vehicle seat.

12. The device as recited in claim 10, wherein the sensory system is configured to record at least one of a pose of the occupant of the at least one vehicle seat, an orientation of the occupant of the at least one vehicle seat, and a head position of the occupant of the at least one vehicle seat.

13. The device as recited in claim 11, wherein the at least one actuator changes the contour of the at least one vehicle seat to support movements of the occupant of the at least one vehicle seat.

14. The device as recited in claim 12, wherein the at least one actuator changes the contour of the at least one vehicle seat to support movements of the occupant of the at least one vehicle seat.

15. The device as recited in claim 13, wherein the device is connected to at least one further sensor for detecting kinematic variables, and wherein a signal from the at least one further sensor is considered in changing the contour of the at least one vehicle seat.

16. The device as recited in claim 14, wherein the device is connected to at least one further sensor for detecting kinematic variables, and wherein a signal from the at least one further sensor is considered in changing the contour of the at least one vehicle seat.

17. The device as recited in claim 11, wherein the device is connected to a restraining system, and wherein the contour of the at least one vehicle seat is adjusted so as to minimize a risk of injury to the occupant of the at least one vehicle seat.

18. The device as recited in claim 12, wherein the device is connected to a restraining system, and wherein the contour of the at least one vehicle seat is adjusted so as to minimize a risk of injury to the occupant of the at least one vehicle seat.

19. The device as recited in claim 15, wherein the device is connected to a restraining system, and wherein the contour of the at least one vehicle seat is adjusted so as to minimize a risk of injury to the occupant of the at least one vehicle seat.

20. The device as recited in claim 16, wherein the device is connected to a restraining system, and wherein the contour of the at least one vehicle seat is adjusted so as to minimize a risk of injury to the occupant of the at least one vehicle seat.
